(19) United States
(12) Patent Application Publication
(10) Pub. No.: US 2018/0071970 A1
(43) Pub. Date: Mar. 15, 2018

(54) METHOD FOR PRODUCING MOLDED ARTICLE BY PRESS MOLDING THERMOPLASTIC RESIN SHEET OR FILM

(71) Applicants: MITSUBISHI GAS CHEMICAL COMPANY, INC., Tokyo (JP); MGC FILSHEET CO., LTD., Saitama (JP)

(72) Inventors: Hiroki ISHII, Fukushima (JP); Haruhiko KUROKAWA, Kanagawa (JP)

(73) Assignees: MITSUBISHI GAS CHEMICAL COMPANY, INC., Tokyo (JP); MGC FILSHEET CO., LTD., Saitama (JP)

(21) Appl. No.: 15/564,557

(22) PCT Filed: Apr. 12, 2016
(86) PCT No.: PCT/JP2016/061748

§ 371 Date: Oct. 5, 2017

(30) Foreign Application Priority Data
Apr. 16, 2015 (JP) 2015-084247

(51) Int. Cl. B29C 51/00; B29B 9/06; B29C 47/00

(52) U.S. Cl. CPC B29C 51/002; B29B 9/065; B29K 2105/12; B29C 47/0021; B29C 47/004; B29C 47/0004

(57) ABSTRACT

A method for producing a hot-press-molded article having an exceptional appearance, while preventing the generation of holes or cracks, by hot-press molding a sheet and film of a thermoplastic resin that contains an inorganic filler. The method includes press molding a resin sheet or resin film that contains a thermoplastic resin and fibrous inorganic filler between an upper mold and a lower mold, wherein the resin sheet contains 40-80 parts by mass of the thermoplastic resin and 20-60 parts by mass of the fibrous inorganic filler in 100 parts by mass of the resin sheet, the thickness of the resin sheet is 0.3-1.2 mm, the average fiber length of the fibrous inorganic filler in the molded article is 50-500 μm, and the length of the surplus portion of the resin sheet arranged on the concave part of the mold used in press molding is 5-50 mm.

### TECHNICAL FIELD

The present invention relates to a method for producing a molded body by press-molding a sheet or film of a thermoplastic resin that contains an inorganic filler. Specifically, the present invention relates to a method of using press molding, wherein the side portion of a press-molded article does not have any resin-unfilled portion or holes/cracks, realizing good outer appearance.

### BACKGROUND ART

Recently, industrial components typified by various components and members of automobiles, electrical and electronic equipments, home appliances, etc., which are produced by press molding of metallic materials, have been replaced by molding materials consisting of an inorganic filler and a thermoplastic resin. This is because molded bodies obtained by using the molding materials have high strength and are lightweight. In this regard, press molding is a method of carrying out molding and processing by providing a deformation such as bending, shearing and compression to various materials, for example, a metal, a plastic material and a ceramic material, using a processing machine, a mold, a tool, etc. Further, press molding is characterized in that a large quantity of products can be produced with a relatively uniform precision. Increase in speed, increase in accuracy, quality stabilization and the like are highly desired for mass production, and for realizing these matters, the improvement of workability and moldability is very highly desired in the market.

Conventionally, as a method for producing a press-molded article having excellent transferability and high-quality outer appearance, a method in which press molding is carried out in a state where the mold surface temperature is higher than the thermal deformation temperature or glass transition temperature of a thermoplastic resin, followed by rapidly cooling the mold, is disclosed (Patent Document 1). However, this press molding method is related to a material in which an inorganic filler is not mixed, and Patent Document 1 does not describe any press molding method to be used in the case where a thermoplastic resin is not easily elongated because an inorganic filler is contained therein.

Regarding methods for press molding using a molding material consisting of an inorganic filler and a thermoplastic resin, as one of techniques suggested for the improvement of outer appearance of molded bodies obtained, a method in which a thermoplastic resin sheet is preheated, softened and cut, and then subjected to mold clamping is disclosed (Patent Document 2). However, this press molding method is considered to be preferred for fiber-enhanced thermoplastic resin sheets having a fiber length of 5 mm or more produced by the sheet forming method. Patent Document 2 does not describe any method for press-molding a thermoplastic resin sheet containing an inorganic filler having a length of 5 mm or less produced by the melt extrusion molding method, in particular, any press molding method in which a sheet is not cut. Further, the sheet forming method is suitably used in the case of producing a molded article having a thickness of 1 mm or more, and when it is used for producing a thin molded article, fibers project from the surface of the molded article, and for this reason, the surface roughness is large and formativeness is insufficient.

### PRIOR ART DOCUMENTS

### Patent Documents

Patent Document 1: Japanese Laid-Open Patent Publication No. 2006-224332
Patent Document 2: Japanese Laid-Open Patent Publication No. H10-100174

### SUMMARY OF THE INVENTION

### Problems to be Solved by the Invention

In order to suppress projection of fibers from surfaces of a thin molded article and to obtain good formativeness, it is effective to adjust the length of an inorganic filler in the molded article to 50 to 500 μm, but when press-molding a sheet or film of a thermoplastic resin containing such an inorganic filler into a shape having unevenness such as a box shape, the resin is broken at the time of mold clamping due to adhesion between the end portions of the sheet or film and the peripheral portion of the mold, the resin component does not enter into the internal portion of the cavity, and as a result, holes/cracks are generated at the side portion of the molded article.

The problem of the present invention is to solve the above-described conventional problem to provide a method for producing a hot-press-molded article having excellent outer appearance by hot-press-molding a thermoplastic resin sheet or film containing an inorganic filler.

### Solution to Problem

The present inventors diligently made researches in order to solve the above-described problem, and found that a heretofore unavailable hot-press-molded article having excellent outer appearance can be obtained by defining the length of a surplus portion of a resin sheet, for example, as represented by 1a to 1d in FIGS. 1 to 6, to be 5 mm to 50 mm.

Specifically, the present invention relates to a method for hot-pressing a thermoplastic resin sheet or film into a shape having unevenness such as a box shape described below, and the summary thereof is as described below.

[1] A method for producing a molded body, the method comprising a step of press molding a resin sheet or resin film that comprises a thermoplastic resin (A) and a fibrous inorganic filler (B) between an upper mold and a lower mold, wherein:

the resin sheet comprises 40 to 80 parts by mass of the thermoplastic resin (A) and 20 to 60 parts by mass of the fibrous inorganic filler (B) in 100 parts by mass of the resin sheet; the thickness of the resin sheet is 0.3 to 1.2 mm; the average fiber length of the fibrous inorganic filler (B) in the molded body is 50 to 500 μm; and

the length of a surplus portion of the resin sheet arranged on the concave portion of the lower mold used in press molding is 5 to 50 mm.

[2] The method for producing a molded body comprising press molding according to item [1], wherein the depth of the concave portion of the lower mold used in press molding is 1 to 30 mm.
[3] The method for producing a molded body comprising press molding according to item [1] or [2], wherein the ratio of the length of the surplus portion to the depth of the concave portion of the lower mold which is defined as the value of (the length of the surplus portion (mm)/(the depth of the concave portion of the lower mold (mm)) is 1.0 to 10.0.
[4] The method for producing a molded body comprising press molding according to any one of items [1] to [3], wherein the resin sheet further comprises a plate-shaped filler in an amount of 0.1 to 10 parts by mass.
[5] The method for producing a molded body comprising press molding according to any one of items [1] to [4], wherein the thermoplastic resin (A) includes an aromatic polycarbonate.
[6] The method for producing a molded body comprising press molding according to any one of items [1] to [5], wherein the length of the surplus portion is 7 mm to 20 mm.
[7] A molded body obtained by the production method according to any one of items [1] to [6].

### Effects of the Invention

According to the method of the present invention, in which a molded body is produced by press-molding a thermoplastic resin sheet or film containing an inorganic filler, for example, into a box shape, it is possible to provide a molded article having excellent outer appearance, wherein the side portion of the molded article does not have any hole or crack. For this reason, the present invention can be suitably used for a method for hot-pressing a sheet or film for thermal shaping which is to be applied to a case for electrical and electronic equipments, etc.

### BRIEF DESCRIPTION OF THE DRAWINGS

FIG. 1 is a cross sectional view schematically showing the first specific example of molds for press molding and a resin sheet.

FIG. 2 is a cross sectional view schematically showing the second specific example of molds for press molding and a resin sheet.

FIG. 3 is a cross sectional view schematically showing the third specific example of molds for press molding and a resin sheet.

FIG. 4 is a cross sectional view schematically showing the fourth specific example of molds for press molding and a resin sheet.

FIG. 5 is a plan view showing a lower mold for press molding and a resin sheet.

FIG. 6 is a cross sectional view schematically showing molds for press molding and a resin sheet used in the Examples.

### DESCRIPTION OF EMBODIMENTS

Hereinafter, the present invention will be described in detail. Note that the present invention is not limited to the below-described embodiments, and can be arbitrarily changed and then carried out without departing from the gist of the present invention.

[Thermoplastic resin (A)]

As the thermoplastic resin (A) (hereinafter sometimes referred to as “the component (A)”) to be used in the molding method of the present invention, well-known resins can be used without any particular limitation.

Examples thereof include polyethylene, polypropylene, modified PPE, an acrylic resin, polystyrene, polyvinyl chloride, ABS resin, a polyester resin (polyethylene terephthalate, polybutylene terephthalate), a polycarbonate resin, polyamide, polyacetal, polysulfone and polyphenylene sulfide. These resins may be used solely, or two or more of them may be used in combination in the form of a mixture or a copolymer.

Among various thermoplastic resins, an aromatic polycarbonate resin is particularly preferred. The aromatic polycarbonate resin is excellent in transparency, impact resistance, heat resistance, etc., and in addition, a molded article obtained therefrom is excellent in size stability, etc., and therefore, it is possible to obtain beautiful outer appearance of a case or the like.

The aromatic polycarbonate resin to be used in the present invention is a branched or unbranched thermoplastic polymer or copolymer, which is obtained, for example, by reacting an aromatic dihydroxy compound or this and a small amount of a polyhydroxy compound with phosgene or carbonic acid diester. The method for producing the aromatic polycarbonate resin is not particularly limited, and it is possible to use an aromatic polycarbonate resin produced by a conventionally known phosgene method (interfacial polymerization method), melting method (transesterification method) or the like. Further, in the case of using the melting method, it is possible to use an aromatic polycarbonate resin in which the amount of OH groups as end groups is adjusted.

Examples of the aromatic dihydroxy compound as a raw material include 2,2-bis(4-hydroxyphenyl)propane (═bisphenol A), tetramethylbisphenol A, bis(4-hydroxyphenyl)-p-diisopropylbenzene, hydroquinone, resorcinol and 4,4-dihydroxydiphenyl, and preferred is bisphenol A. Further, it is also possible to use a compound in which at least one tetraalkylphosphonium sulfonate is bound to the above-described aromatic dihydroxy compound.

For obtaining a branched aromatic polycarbonate resin, a part of the above-described aromatic dihydroxy compound may be substituted with the below-described branching agent, that is, a polyhydroxy compound such as phloroglucin, 4,6-dimethyl-2,4,6-tri(4-hydroxyphenyl)heptene-2, 4,6-dimethyl-2,4,6-tri(4-hydroxyphenyl)heptane, 2,6-dimethyl-2,4,6-tri(4-hydroxyphenyl)heptene-3,1,3,5-tri(4-hydroxyphenyl)benzene and 1,1,1-tri(4-hydroxyphenyl)ethane, or a compound such as 3,3-bis(4-hydroxyaryl)oxyindole (═isatinbisphenol), 5-chloroisatin, 5,7-dichloroisatin and 5-bromoisatin. The amount of the compound to be used for substitution is usually 0.01 to 10 mol %, and preferably 0.1 to 2 mol % relative to the aromatic dihydroxy compound.

As the aromatic polycarbonate resin, among the above-described ones, preferred is a polycarbonate resin derived from 2,2-bis(4-hydroxyphenyl)propane or a polycarbonate copolymer derived from 2,2-bis(4-hydroxyphenyl)propane and another aromatic dihydroxy compound. Further, the aromatic polycarbonate resin may be a copolymer mainly composed of a polycarbonate resin such as one copolymerized with a polymer or oligomer having a siloxane structure.

The above-described aromatic polycarbonate resins may be used solely, or two or more of them may be used by mixing thereof.

For adjusting the molecular weight of the aromatic polycarbonate resin, a monovalent aromatic hydroxy compound may be used. Examples of the monovalent aromatic hydroxy compound include m-methylphenol, p-methylphenol, m-propylphenol, p-propylphenol, p-tert-butylphenol and p-long chain alkyl-substituted phenol.

The molecular weight of the aromatic polycarbonate resin to be used in the present invention may be suitably selected and arbitrarily determined according to intended use, but from the viewpoint of moldability, strength, etc., the viscosity-average molecular weight [Mv] of the aromatic polycarbonate resin is 15,000 to 40,000, and preferably 15,000 to 30,000. When the viscosity-average molecular weight is 15,000 or more, the mechanical strength tends to be further improved, and it is more preferred in the case of applications having a high demand for mechanical strength. As used herein, the viscosity-average molecular weight [Mv] refers to a viscosity-average molecular weight [Mv] obtained by conversion from the solution viscosity. As a solvent, methylene chloride is used, the limiting viscosity [η] (unit: dl/g) at 20° C. is obtained using an Ubbelohde viscometer, and calculation is made according to Schnell's viscosity equation, i.e., η=1.23×10⁻⁴M^{0.83}, thereby obtaining a value of the viscosity-average molecular weight (Mv). In this regard, the value of the limiting viscosity [η] is obtained by carrying out the measurement of the specific viscosity [ηₛₚ] with each solution concentration [c] (g/dl) and calculation according to the below-described formula:

$$η = {lim}_{c \to 0} {η}_{sp} / c$$

The viscosity-average molecular weight of the aromatic polycarbonate resin is more preferably 17,000 to 30,000, and particularly preferably 19,000 to 27,000. Further, two or more types of aromatic polycarbonate resins respectively having different viscosity-average molecular weights may be mixed together, and in this case, an aromatic polycarbonate resin having a viscosity-average molecular weight that is not within the above-described preferred range may be used for a mixture. In this case, it is desired that the viscosity-average molecular weight of the mixture is within the above-described range.

In the present invention, the ratio of the thermoplastic resin (A) in 100 parts by mass of the resin sheet is 40 to 80 parts by mass, preferably 45 to 75 parts by mass, and more preferably 50 to 70 parts by mass

### [Fibrous Inorganic Filler (B)]

The thermoplastic resin sheet to be used in the present invention is characterized in that it contains the fibrous inorganic filler (B) (hereinafter sometimes referred to as “the component (B)”) for the purpose of improving bending characteristics such as bending elastic modulus and bending strength of molded articles.

As the fibrous inorganic filler (B) to be used in the present invention, a glass-based reinforcing material or a carbon-based reinforcing material can be used because of its excellent effects of reinforcing thermoplastic resin compositions. In particular, a glass-based reinforcing material is preferably used. Every glass-based reinforcing material is classified into a fibrous inorganic filler or a plate-like inorganic filler based on its shape. As a fibrous glass fiber to be used in the present invention, any publicly-known glass fiber in any form can be used regardless of the form of the glass fiber at the time of blending such as a chopped strand, a roving glass and a (long-fiber) masterbatch of a thermoplastic resin and a glass fiber. From the viewpoint of productivity, a chopped strand (chopped glass fiber) is preferred. The average length of the fibrous inorganic filler (B) to be used as a raw material is 50 μm or more, preferably 1 mm or more, and more preferably 2 mm or more.

The fibrous inorganic filler (B) to be used as a raw material is required to have a predetermined length or longer because it is broken and shorten during processes of producing a resin pellet, molding a sheet, etc.

The average length of the inorganic filler in the molded article is 50 to 500 μm, preferably 100 to 500 μm, and more preferably 150 to 500 μm. When the fiber is too long, the formativeness of the sheet or film is deteriorated, and there is a possibility that the fiber projects from the surface of the sheet or film. Meanwhile, when the fiber is too short, the rigidity of the molded article is insufficient.

The fiber length is measured as described below. Specifically, about 2 g of the molded article containing the fibrous inorganic filler is left in an electric furnace at 600° C. for 2 hours, then the fibrous inorganic filler remaining in the form of ash is spread over a glass, and it is observed using an optical microscope and photographed. After that, 500 fibers are measured using an image analyzer (WinRoof2013 manufactured by Mitani Corporation) and the average value thereof is calculated. Note that since the fibrous inorganic filler is broken at the time of forming the sheet or film as described above, the actual fiber length of the fiber contained in the sheet or film is shorter than the fiber length of the fibrous inorganic filler used as a raw material. For this reason, the actual fiber length of the fibrous inorganic filler in the molded article obtained by using the sheet or film is measured according to the above-described method.

Further, the average fiber diameter of the fibrous inorganic filler is preferably 1 to 50 μm, and more preferably 3 to 40 μm.

In the present invention, one type of an inorganic filler may be used solely, or two or more types of inorganic fillers may be used as a mixture. For example, two or more types of glass fibers (including a milled fiber) respectively having different average fiber diameters, average lengths and the like may be used in combination, and two or more types of glass flakes respectively having different average particle diameters, average thicknesses and aspect ratios may be used in combination. Further, one or more types of glass fibers (including a milled fiber) may be used in combination, and one or more types of flakes may be used in combination with one or more types of glass fibers (including a milled fiber).

For the purpose of size stabilization, glass beads may be used in combination.

These inorganic fillers may be subjected to the surface treatment using a surface treatment agent, and by the surface treatment, adhesion between the resin component and granular glass is improved, thereby realizing high mechanical strength.

In the present invention, the ratio of the fibrous inorganic filler (B) in 100 parts by mass of the resin sheet is 20 to 60 parts by mass, preferably 25 to 55 parts by mass, and more preferably 30 to 50 parts by mass.

Note that orientation of the fibrous inorganic filler is not particularly limited. For example, the filler may be oriented in one direction prior to press molding, and then the state of orientation may be changed by press molding to relax anisotropy of filler orientation so that the filler is not oriented only in one direction.

### <Other Inorganic Fillers>

In the present invention, other than the above-described inorganic fillers, a silicate-based reinforcing material may also be used, and as a fibrous filler, wollastonite and the like can be used, and as a plate-like filler, talc, mica and the like can be used. In addition, as other fibrous fillers, metal fibers and whiskers such as potassium titanate whisker, calcium carbonate whisker, aluminium borate whisker, titanium oxide whisker, zinc oxide whisker and magnesium sulfate whisker can be used, and as other plate-like fillers, metal flakes, silica, alumina, calcium carbonate, etc. can be used. Similarly, regarding the above-described other inorganic fillers, one type may be used solely, or two or more types may be used as a mixture. When adding an inorganic filler that is not fibrous, for example, a plate-like filler, the amount thereof to be used is 0.1 to 10 parts by mass, preferably 1 to 10 parts by mass, and more preferably 5 to 10 parts by mass relative to 100 parts by mass of the resin sheet.

Without significantly impairing the scope of the present invention, a phosphorus-based thermal stabilizer, an antioxidant, a weather resistance improving agent, an additive for improving strength, etc., can be blended in the resin.

### [Method for Producing Thermoplastic Resin Composition]

The method for producing the thermoplastic resin composition of the present invention is not limited, and a wide range of publicly-known methods for producing a thermoplastic resin composition can be employed.

Specific examples thereof include a method in which the thermoplastic resin (A) and the fibrous inorganic filler (B) of the present invention, and the phosphorus-based thermal stabilizer, the antioxidant and other components, which are blended according to need, are mixed together in advance using, for example, a mixing machine such as a tumbler, a Henschel mixer and a super mixer, and then the mixture is melt-kneaded using a mixing machine such as a Bunbury mixer, a roller, a Brabender, a single screw kneading extruder, a twin screw kneading extruder and a kneader.

Further, for example, it is also possible to produce the thermoplastic resin composition of the present invention by not mixing components in advance or mixing only a part of components in advance and by carrying out supply to an extruder using a side feeder for melt-kneading. In particular, since the inorganic filler (B) suppresses crushing, it is preferably supplied from a side feeder placed at the downstream side of the extruder, separately from the resin component, to be mixed.

### [Method for Producing Sheet or Film]

As the method for producing the thermoplastic resin sheet or film of the present invention, a melt extrusion method (e.g., a T-die molding method) is preferably used.

Note that in this specification, the “sheet” is not clearly distinguished from the “film”, and these terms are used as the same meaning.

### [Press Molding Method]

As used herein, press molding means a method of obtaining a molded body by providing a deformation such as bending, shearing and compression to various materials, for example, a metal, a plastic material and a ceramic material, using a mold (die), a processing machine, a tool, etc. Further, examples of the press molding method include the die pressing method, the rubber pressing method (isostatic molding method) and the extrusion molding method, in each of which molding is carried out using a mold.

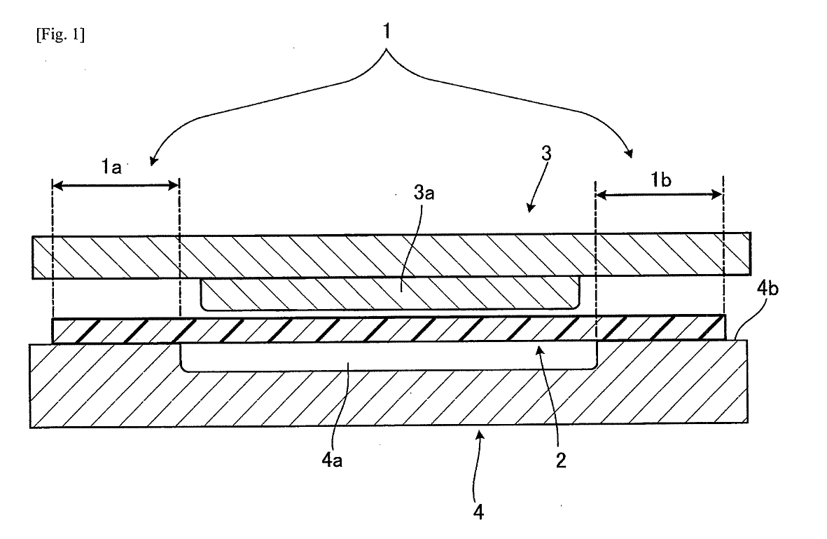

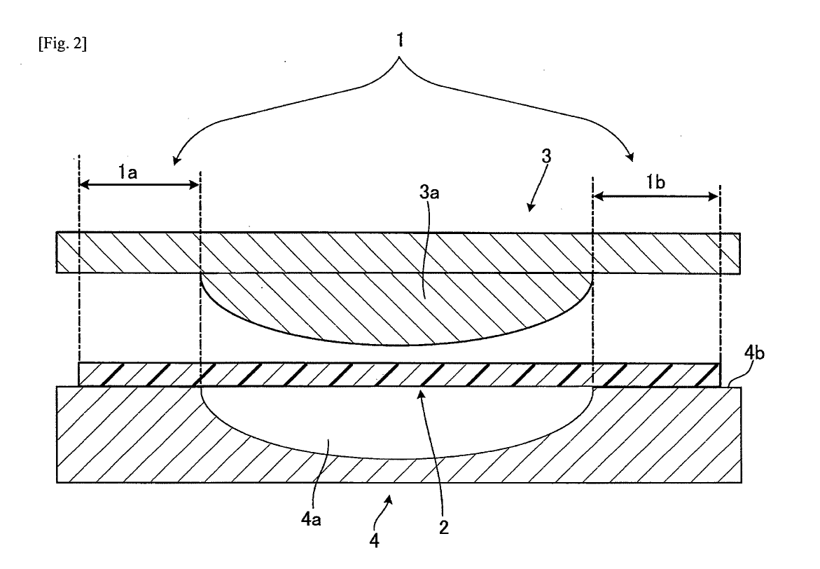

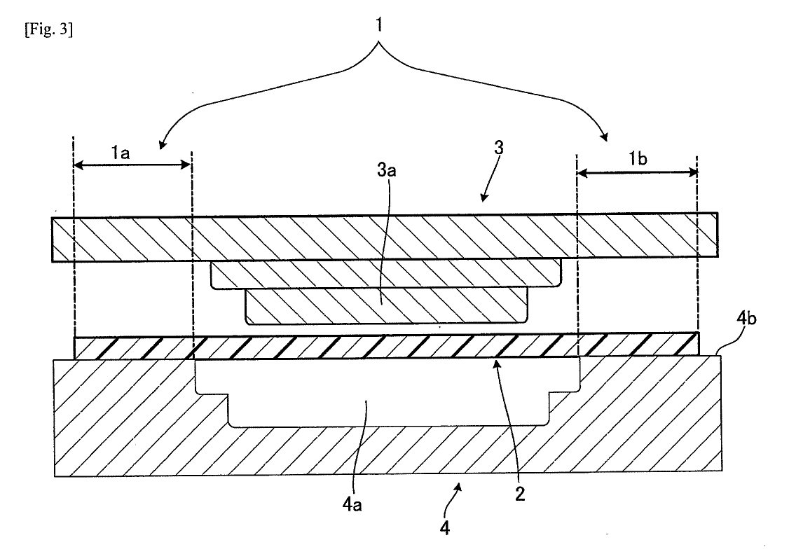

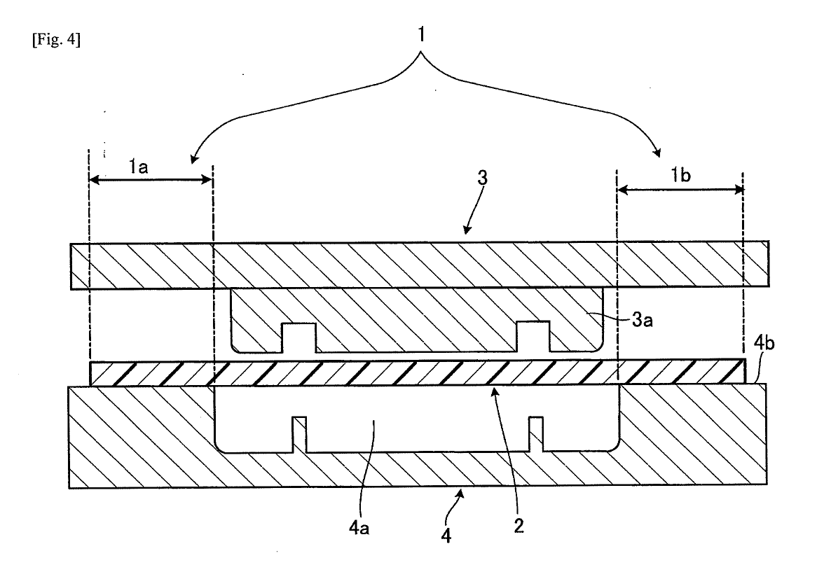

In the present invention, at the time of press-molding the thermoplastic resin sheet, the length of each of surplus portions of the resin sheet is adjusted to be 5 mm to 50 mm. For example, in FIGS. 1-6, each of which shows a specific example of molds for press molding and a resin sheet, the length of a surplus portion 1 of a resin sheet 2 (1a to 1d) is adjusted to be 5 mm to 50 mm. Specifically, when the resin sheet 2 is arranged between an upper mold 3 having a convex portion 3a and a lower mold 4 so as to cover a concave portion 4a of the lower mold 4, the length of each of surplus portions 1a to 1d of the resin sheet 2 is 5 mm to 50 mm.

In the present invention, the surplus portion of the resin sheet means a region of the resin sheet arranged on the lower mold prior to pressing that contacts with a flat portion of the lower mold (excluding the concave portion). Further, the length of the surplus portion means the distance between the outline of the concave portion of the lower mold and the outline of the resin sheet in the surplus portion (the shortest length).

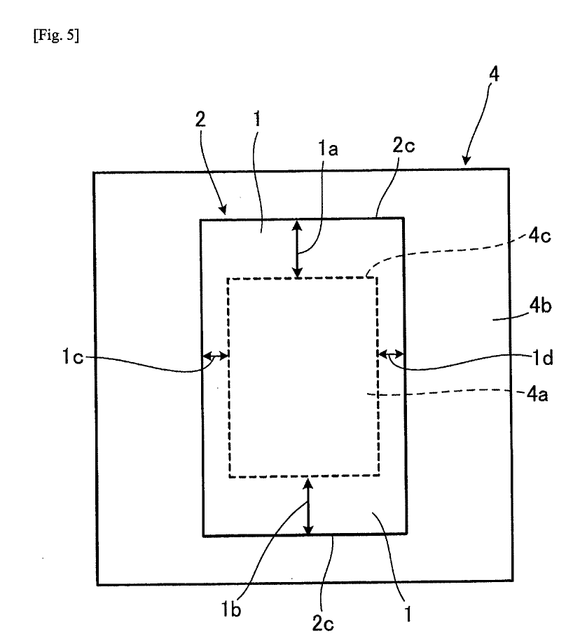

For example, in FIG. 5 that is a plan view showing a resin sheet 2 and a lower mold 4 prior to pressing, the lengths of a surplus portion 1 of the resin sheet 2 are represented by 1a to 1d, and these lengths are respectively 5 mm to 50 mm. Note that in FIGS. 1-5, the lengths 1a and 1b of the surplus portion are the same, and the lengths 1c and 1d are the same, but when these lengths are different, it is preferred that all the lengths 1a to 1d are within the range of 5 mm to 50 mm. When a plurality of lengths of a surplus portion in one sheet are different, at least a part of lengths of the surplus portion are required to be within the range of 5 mm to 50 mm. For example, in FIG. 5, one of the length 1a (or 1b) and the length 1c (or 1d) of the surplus portion is within the range of 5 mm to 50 mm. Further, the average value of a plurality of lengths of the surplus portion different from each other, for example, the average value of the length 1a (or 1b) and the length 1c (or 1d) of the surplus portion in FIG. 5, is preferably within the range of 5 mm to 50 mm.

Note that in FIG. 5, the outline 2c of the resin sheet 2 and the outline 4c of the concave portion 4a of the lower mold 4 are rectangular, but the shape of the resin sheet 2 and that of the concave portion 4a of the lower mold 4 are not limited to those shown in FIG. 5. For example, even when at least one of the resin sheet 2 and the concave portion 4a of the lower mold 4 has a shape other than a rectangular shape such as an elliptical shape, at least a part of the lengths of the surplus portion defined as described above are within the range of 5 mm to 50 mm, and preferably a plurality of lengths of the surplus portion, and particularly preferably all the lengths of the surplus portion are within the above-described range. In addition, the average value of a plurality of lengths of the surplus portion is preferably within the above-described range.

Thus, by adjusting the lengths of the resin sheet, breakage of resin at the time of mold clamping due to adhesion between the end portions of the sheet and the peripheral portion of the mold is suppressed, thereby obtaining a molded article having excellent outer appearance, wherein the side portion of the molded article does not have any hole or crack.

The main reason thereof is as described below. A resin sheet containing a filler tends to be easily broken, and it is usually broken due to several percent elongation. Further, when the resin sheet containing the filler contacts with a mold at a high temperature, the resin on the contact surface is melted to generate an adhesive force. At the time of pressing after that, the resin sheet containing the filler is pressed into a concave portion of a lower mold. In this regard, when the size of the surplus portion is appropriate, the aforementioned adhesive force is small, and the resin sheet is drawn into the concave portion to realize normal shaping. Meanwhile, when the size of the surplus portion of the resin sheet is too large, since the contact area of the resin sheet relative to the lower mold is large, a larger adhesive force is generated, and the resin sheet is not drawn into the concave portion of the lower mold, pulled and elongated, and is easily broken. For this reason, there is a high possibility that normal shaping cannot be realized by a resin sheet containing a filler with a large surplus portion.

When the surplus portion of the resin sheet is too small, it may be difficult to form a molded body on the periphery of the concave portion of the lower mold. For this reason, the value of the ratio of the length of the surplus portion of the resin sheet (mm)/the depth of the concave portion of the lower mold (mm) is preferably 1.0 or more, and more preferably 1.2 or more. Further, the value of the ratio of the length of the surplus portion (mm)/the depth of the concave portion of the lower mold (mm) is preferably 10.0 or less. Note that the depth of the concave portion of the lower mold is a distance between the opening of the concave portion of the lower mold and the deepest region of the concave portion.

The length of the surplus portion of the resin sheet is preferably 5 to 40 mm, more preferably 7 to 30 mm, and particularly preferably 7 to 20 mm.

Further, the thickness of the resin sheet is 0.3 to 1.2 mm, preferably 0.4 to 1.1 mm, and more preferably 0.5 to 1.0 mm. When the resin sheet is too thin, the side portion is easily broken at the time of shaping, and in addition, the rigidity of the molded body is insufficient. When the resin sheet is too thick, the formativeness of the R portion (radiused or curved portion) of the molded body is insufficient.

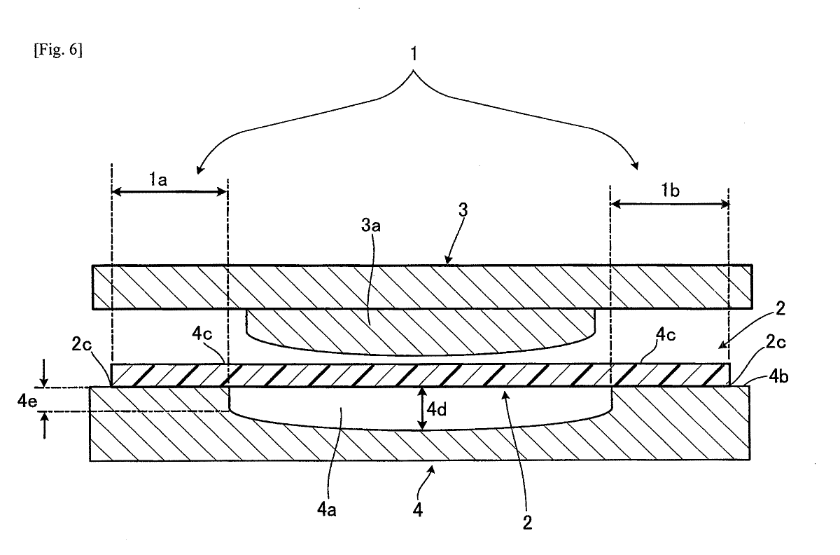

As described above, the depth of the concave portion of the lower mold to be used in the present invention corresponds to a length from the surface on which the sheet is arranged prior to pressing to the deepest portion of the concave portion. For example, in FIG. 6, the depth of the lower mold 4 represented by 4d is 1 mm to 50 mm, preferably 1 mm to 30 mm, and more preferably 1 mm to 20 mm.

When the depth of the lower mold exceeds 50 mm, the contact area between the end potions of the sheet and the peripheral portion of the mold is larger, the resin is broken at the time of mold clamping and does not enter into the internal portion of the cavity, and holes/cracks tend to be easily generated at the side portion of the molded article. Similar to the depth 4d, when the side depth 4e of the concave portion of the lower mold exceeds 50 mm, holes/cracks are easily generated at the side portion of the molded article. Accordingly, the value of the side depth 4e is preferably within the above-described range defined with respect to the depth 4d.

The thermoplastic resin sheet may be one layer, or may be laminated so that a multilayer constitution can be provided. Examples of heating media to be used for heating a mold include hot water, water vapor, heating oil, an electric heating body, ultrasonic wave, electromagnetic induction and a combined use thereof. As a cooling medium to be used for decreasing the temperature of a mold, at least one of cold water and cooling oil is preferably used.

For temperature setting at the time of heating, supply of cold water/cooling oil is stopped and a mold is heated. Further, at the time of cooling, supply of hot water/heating steam/heating oil is stopped or supply of a current to an ultrasonic oscillator, a heater or the like is stopped, and cold water and cooling oil are supplied through the same pipeline for mold temperature adjustment or separate pipelines for mold temperature adjustment respectively, there by carrying out cooling. When a heating medium and a cooling medium are liquid, the same pipeline can be used for them.

Examples of applications of the press-molded article of the present invention obtained in this way include electrical and electronic equipments, office automation equipments, information terminal devices typified by smartphones and tablet PCs, machine components, home appliances, vehicle components, building components, various containers, leisure goods/sundries, components for lighting equipments, etc. and cases. In particular, because of excellent surface smoothness, the molded article produced according to the present invention is very suitably used for cases for smartphones, tablet PCs and the like which require high design property.

### EXAMPLES

Hereinafter, the present invention will be specifically described by way of working examples and comparative examples. However, the present invention is not limited thereby and can be arbitrarily changed and then carried out within a range in which the effects of the present invention are exerted.

Methods for measurement/evaluation and materials used in the working examples and comparative examples are described below

### [Methods for Measurement/Evaluation]

### <Cracks of Side Portion>

The case where the side portion of the hot-press-molded article does not have any unfilled portion or hole/crack was evaluated as “particularly good”, the case where the side portion has a partially thinned portion but does not have any hole/crack was evaluated as “good”, and the case where the side portion has a hole/crack was evaluated as “poor”.

### <Formativeness>

The mold shape was transferred. The case where all the surfaces other than the side portion are smooth was evaluated as “particularly good”, the case where there is a portion with slightly poor smoothness but the surfaces are totally smooth was evaluated as “good”, and the case where all the surfaces other than the side portion have poor smoothness was evaluated as “poor”.

### <Rigidity>

A cylindrical weight having a diameter of 30 mm was put on the central portion of the press-molded article, and the maximum value of deflection obtained when applying a static load of 4.5 N was measured. The case where the maximum value of deflection was less than 5 mm was evaluated as “particularly good”, the case where the maximum value was 5 mm or more and less than 10 mm was evaluated as “good”, and the case where the maximum value was 10 mm or more was evaluated as “poor”.

### <Fiber Length>

About 2 g of the molded article was left in an electric furnace at 600° C. for 2 hours, then the inorganic filler remaining in the form of ash was spread over a glass, and it was observed using an optical microscope and photographed. After that, 500 fibers were measured using an image analyzer (WinRoof2013 manufactured by Mitani Corporation) and the average value thereof was calculated.

### [Materials Used]

### <Thermoplastic Resin (A)>

### <(A-1) Aromatic Polycarbonate>

Bisphenol A-type aromatic polycarbonate produced by interfacial polymerization method (“Iupilon (registered trademark) S-3000FN” manufactured by Mitsubishi Engineering-Plastics Corporation)

### <(A-2) Polypropylene>

Homo-type polypropylene (“NOVATEC (registered trademark) PP MA-3H” manufactured by Japan Polypropylene Corporation)

### <(A-3) Polyester>

Polybutylene terephthalate (“NOVADURAN (registered trademark) 5010R5” manufactured by Mitsubishi Engineering-Plastics Corporation)

### <Inorganic Filler (B)>

### <(B-1) Fibrous Filler>

(B-1-1) Glass chopped strand (“T-571” manufactured by Nippon Electric Glass Co., Ltd., average fiber diameter: 13 μm, average fiber length: 3 mm, aminosilane treated, and bound with heat-resistant urethane)
(B-1-2) Glass chopped strand (average fiber diameter: 7 μm, average fiber length: 3 mm, aminosilane treated, and bound with heat-resistant urethane) (hereinafter referred to as “7φ”)
(B-1-3) Glass fiber, average fiber diameter: 17 μm, fiber length: 10 to 50 mm (hereinafter referred to as “17φ”)
(B-1-4) Glass chopped strand with flat-shaped cross-section, average longer diameter: 24 μm/average shorter diameter: 7 μm (hereinafter referred to as “flat”)
(B-1-5) Carbon fiber (chopped strand) (“TR-06U” manufactured by Mitsubishi Rayon Co., Ltd., average fiber diameter: 7 μm, average fiber length: 6 mm, bound with urethane-based compound, without surface treatment)

### <(B-2) Plate-Like Filler>

(B-2-1) Glass flake (“Glass Flake MEG160FY-M01” manufactured by Nippon Sheet Glass Co., Ltd., average particle diameter: 160 average thickness: 0.7 μm, aminosilane epoxysilane treated) (hereinafter referred to as “FY-M01”)

### <(B-3) Spherical Filler>

(B-3-1) Glass beads (“EGB731B” manufactured by Potters-Ballotini Co., Ltd., average particle diameter: 18 μm, aminosilane treatment)

### Example 1

### <Production of Resin Pellet>

As the thermoplastic resin (A), an aromatic polycarbonate (A-1) was used, and as the inorganic filler (B), a glass chopped strand (B-1-1) was used.

A compound of an aromatic polycarbonate resin composition was kneaded using a twin screw extruder having one vent, TEX30α (C18 block, L/D=63) manufactured by The Japan Steel Works, Ltd. at a screw rotation speed of 200 rpm, at a discharge rate of 20 kg/hour, and at a cylinder temperature of 270° C., and the molten resin extruded into a strand-like shape was rapidly cooled in a water bath and pelletized using a pelletizer, thereby obtaining a resin pellet. The component (A) was supplied from the upstream side (C1) of the extruder, and the component (B) was supplied from the downstream side (C13 barrel) of the extruder using a side feeder with a mixing ratio shown in Tables 1 and 2.

### <Production of Resin Sheet>

Using the above-described resin pellet as a raw material, a resin sheet having a width of 400 mm and a thickness shown in Tables 1-3 was formed using a twin screw extruder with a barrel diameter of 32 mm and screw L/D=35 at a discharge rate of 20 kg/hour, at a screw rotation speed of 200 rpm, and at a cylinder temperature of 270° C. The resin that flowed out from a die was guided to three mirror-finished polishing rolls, and in this regard, the temperatures of the first roll, the second roll and the third roll were set at 160° C. The thickness of each sheet was adjusted by adjusting the take-over speed. Note that the nip pressure between the first roll and the second roll was 5 MPa (oil pressure indication).

### <Hot Pressing Method>

Regarding the mold, a mold made of silicone rubber not having a heating/cooling circuit was used as an upper mold 3 (core type), a mold made of steel having a heating circuit using electromagnetic induction and a cooling circuit using cold water was used as a lower mold 4 (cavity type), the size of the projection plane of a box-type molded article was 190×240 mm, the side depth 4e was 7 mm, and the depth of the central portion 4d was 15 mm (see FIG. 6). The lower mold 4 was heated to 200° C., and after that, a resin sheet 2, which was cut in a manner such that the surplus portion of the sheet had a specific length shown in Tables 1 and 2 relative to the mold, was put on the lower mold 4 to cover the concave portion 4a, mold clamping was carried out under pressurized air of 1 MPa, and it was retained for 1 minute, thereby molding the resin sheet 2. Next, the lower mold 4 was cooled to 80° C., thereby obtaining a thermally-shaped article.

Note that in Example 1, since the length of the surplus portion of the sheet was 20 mm (see Table 1) and the distance from the opening of the concave portion of the lower mold (lower mold 4) to the deepest region thereof was 15 mm (the depth of the central portion 4d), “the length of the surplus portion/the depth of the concave portion of the lower mold” is 1.3 (20 (mm)/15 (mm)). Thus, by increasing the length of the surplus portion relative to the depth of the concave portion of the lower mold, generation of a resin-unfilled portion at the side portion of the molded article formed from the sheet can be surely prevented.

### Example 2

The process was carried out in a manner similar to that in Example 1, except that polypropylene (A-2) was used as the thermoplastic resin, the content of the inorganic filler (B) was 30 wt %, the cylinder temperature at the time of compounding was 220° C., the cylinder temperature at the time of producing a resin sheet was 220° C., the temperatures of the first to third rolls were 60° C., and the temperature of heating the lower mold at the time of hot pressing was 190° C.

### Example 3

The process was carried out in a manner similar to that in Example 1, except that polybutylene terephthalate (A-3) was used as the thermoplastic resin, the content of the inorganic filler (B) was 30 wt %, the cylinder temperature at the time of compounding was 265° C., the cylinder temperature at the time of producing a resin sheet was 265° C., the temperatures of the first to third rolls were 140° C., and the temperature of heating the lower mold at the time of hot pressing was 180° C.

### Example 4

The process was carried out in a manner similar to that in Example 1, except that the content of the inorganic filler (B) was 55 wt %.

### Example 5

The process was carried out in a manner similar to that in Example 1, except that a glass chopped strand with a diameter of 7 μm (B-1-2) was used as the inorganic filler (B).

### Example 6

The process was carried out in a manner similar to that in Example 1, except that a glass chopped strand with flat-shaped cross-section (B-1-4) was used as the inorganic filler (B).

### Example 7

The process was carried out in a manner similar to that in Example 1, except that 30 wt % of a carbon fiber (B-1-5) was used as the inorganic filler (B).

### Example 8

The process was carried out in a manner similar to that in Example 1, except that 40 wt % of a glass chopped strand with circular cross-section with a diameter of 13 μm (B-1-1) and 10 wt % of a glass flake with a thickness of 0.7 μm (B-2-1) were used in combination as the inorganic filler (B).

### Example 9

The process was carried out in a manner similar to that in Example 1, except that the length of the surplus portion of the sheet was 5 mm.

### Example 10

The process was carried out in a manner similar to that in Example 1, except that the length of the surplus portion of the sheet was 40 mm.

### Example 11

The process was carried out in a manner similar to that in Example 1, except that the thickness of the sheet was 0.3 mm.

### Example 12

The process was carried out in a manner similar to that in Example 1, except that the thickness of the sheet was 1.2 mm.

### Comparative Example 1

The process was carried out in a manner similar to that in Example 1, except that the length of the surplus portion of the sheet was 60 mm.

### Comparative Example 2

The process was carried out in a manner similar to that in Example 1, except that the length of the surplus portion of the sheet was 2 mm.

### Comparative Example 3

The process was carried out in a manner similar to that in Example 1, except that the thickness of the sheet was 0.2 mm.

### Comparative Example 4

The process was carried out in a manner similar to that in Example 1, except that the thickness of the sheet was 1.3 mm.

### Comparative Example 5

The process was carried out in a manner similar to that in Example 1, except that the content of the inorganic filler (B) was 10 wt %.

### Comparative Example 6

The process was carried out in a manner similar to that in Example 1, except that the content of the inorganic filler (B) was 65 wt %.

### Comparative Example 7

The process was carried out in a manner similar to that in Example 1, except that 40 wt % of glass beads (B-3-1) was used as the inorganic filler (B).

### Comparative Example 8

Polypropylene powder (A-2) and glass fiber having a fiber length of 10 to 50 mm (B-1-3) were dispersed in water to carry out sheet forming to obtain a web-like molding material. It was dried with hot air at 180° C., subjected to hot pressing at 220° C. and at 0.2 MPa and then subjected to cold pressing at the same pressure, thereby obtaining a glass fiber-enhanced polypropylene molded article containing 40 wt % of glass fiber.

### [Evaluation Results]

TABLE 1

| | | Deno- | | Exam- | Exam- | Exam- | Exam- | Exam- | Exam- | Exam- |
|---|---|---|---|---|---|---|---|---|---|---|
| | Items | tation | | ple 1 | ple 2 | ple 3 | ple 4 | ple 5 | ple 6 | ple 7 |
| Compo- | (A) Thermoplastic | A-1 | Bisphenol A-type aromatic | 60 | | | 45 | 60 | 60 | 70 |
| sition | Resin | | polycarbonate | | | | | | | |
| of Sheet | | A-2 | Homo-type polypropylene | | 70 | | | | | |
| | | A-3 | Polybutylene terephthalate | | | 70 | | | | |
| | (B) Inorganic | B-1-1 | Glass chopped strand φ13μ | 40 | 30 | 30 | 55 | | | |
| | Filler | B-1-2 | Glass chopped strand φ7μ | | | | | 40 | | |
| | | B-1-3 | Glass chopped strand φ17μ | | | | | | | |
| | | B-1-4 | Glass chopped strand with | | | | | | 40 | |
| | | | flat-shaped cross-section | | | | | | | |
| | | B-1-5 | Carbon fiber (chopped strand) | | | | | | | 30 |
| | | B-2-1 | Glass flake (FY-M01) | | | | | | | |
| | | B-3-1 | Glass beads (EGB731B) | | | | | | | |
| | Fiber length | | | 300 | 300 | 300 | 280 | 200 | 350 | 300 |
| | (average | | | | | | | | | |
| | length, μm) | | | | | | | | | |
| Condi- | Thickness of | | | 0.7 | 0.7 | 0.7 | 0.7 | 0.7 | 0.7 | 0.7 |
| tions | sheet, mm | | | | | | | | | |
| for press | Length of surplus | | | 20 | 20 | 20 | 20 | 20 | 20 | 20 |
| molding | portion of sheet, mm | | | | | | | | | |
| | Heating | | | 200 | 190 | 180 | 200 | 200 | 200 | 200 |
| | temperature, ° C. | | | | | | | | | |
| | Retention time, min | | | 1 | 1 | 1 | 1 | 1 | 1 | 1 |
| | Cooling | | | 80 | 80 | 80 | 80 | 80 | 80 | 80 |
| | temperature, ° C. | | | | | | | | | |
| | Pressure, MPa | | | 1 | 1 | 1 | 1 | 1 | 1 | 1 |
| Eval- | Cracks of side | | | Partic- | Partic- | Good | Good | Partic- | Partic- | Good |
| uation | portion | | | ularly | ularly | | | ularly | ularly | |
| | | | | good | good | | | good | good | |
| | Formativeness | | | Partic- | Partic- | Partic- | Good | Good | Partic- | Good |
| | | | | ularly | ularly | ularly | | | ularly | |
| | | | | good | good | good | | | good | |
| | Rigidity | | | Partic- | Good | Partic- | Partic- | Partic- | Partic- | Partic- |
| | (maximum | | | ularly | (8.4) | ularly | ularly | ularly | ularly | ularly |
| | deflection, mm) | | | good | | good | good | good | good | good |
| | | | | (4.0) | | (3.9) | (3.3) | (3.7) | (3.6) | (3.2) |

TABLE 2

| | | Deno- | | Exam- | Exam- | Exam- | Exam- | Exam- |
|---|---|---|---|---|---|---|---|---|
| | Items | tation | | ple 8 | ple 9 | ple 10 | ple 11 | ple 12 |
| Compo- | (A) Thermoplastic | A-1 | Bisphenol A-type aromatic | 50 | 60 | 60 | 60 | 60 |
| sition | Resin | | polycarbonate | | | | | |
| of Sheet | | A-2 | Homo-type polypropylene | | | | | |
| | | A-3 | Polybutylene terephthalate | | | | | |
| | (B) Inorganic | B-1-1 | Glass chopped strand φ13μ | 40 | 40 | 40 | 40 | 40 |
| | Filler | B-1-2 | Glass chopped strand φ7μ | | | | | |
| | | B-1-3 | Glass chopped strand φ17μ | | | | | |
| | | B-1-4 | Glass chopped strand with | | | | | |
| | | | flat-shaped cross-section | | | | | |
| | | B-1-5 | Carbon fiber (chopped strand) | | | | | |
| | | B-2-1 | Glass flake (FY-M01) | 10 | | | | |
| | | B-2-1 | Glass beads (EGB731B) | | | | | |
| | Fiber length | | | 300 | 300 | 300 | 300 | 300 |
| | (average | | | | | | | |
| | length, μm) | | | | | | | |
| Condi- | Thickness | | | 0.7 | 0.7 | 0.7 | 0.3 | 1.2 |
| tions | of sheet, mm | | | | | | | |
| for press | Length of surplus | | | 20 | 5 | 40 | 20 | 20 |
| molding | portion of sheet, mm | | | | | | | |
| | Heating | | | 200 | 200 | 200 | 200 | 200 |
| | temperature, ° C. | | | | | | | |
| | Retention time, min | | | 1 | 1 | 1 | 1 | 1 |
| | Cooling | | | 80 | 80 | 80 | 80 | 80 |
| | temperature, ° C. | | | | | | | |
| | Pressure, MPa | | | 1 | 1 | 1 | 1 | 1 |
| Eval- | Cracks of | | | Good | Partic- | Partic- | Good | Partic- |
| uation | side portion | | | | ularly | ularly | | ularly |
| | | | | | good | good | | good |
| | Formativeness | | | Partic- | Partic- | Partic- | Partic- | Partic- |
| | | | | ularly | ularly | ularly | ularly | ularly |
| | | | | good | good | good | good | good |
| | Rigidity | | | Partic- | Partic- | Partic- | Good | Partic- |
| | (maximum | | | ularly | ularly | ularly | (9.7) | ularly |
| | deflection, mm) | | | good | good | good | | good |
| | | | | (3.6) | (4.0) | (4.0) | | (1.2) |

TABLE 3

| | | | | Comparative | Comparative | Comparative | Comparative |
|---|---|---|---|---|---|---|---|
| | Items | Denotation | | Example 1 | Example 2 | Example 3 | Example 4 |
| Composition | (A) Thermosplastic Resin | A-1 | Bisphenol A-type aromatic | 60 | 60 | 60 | 60 |
| of Sheet | | | polycarbonate | | | | |
| | | A-2 | Homo-type polyproplene | | | | |
| | | A-3 | Polybutylene terephthalate | | | | |
| | (B) Inorganic Filler | B-1-1 | Glass chopped strand φ13μ | 40 | 40 | 40 | 40 |
| | | B-1-2 | Glass chopped strand φ7μ | | | | |
| | | B-1-3 | Glass chopped strand φ17μ | | | | |
| | | B-1-4 | Glass chopped strand with | | | | |
| | | | flat-shaped cross-section | | | | |
| | | B-1-5 | Carbon fiber (chopped strand) | | | | |
| | | B-2-1 | Glass flake (FY-M01) | | | | |
| | | B-3-1 | Glass beads (EGB731B) | | | | |
| | Fiber length | | | 300 | 300 | 300 | 300 |
| | (average length, μm) | | | | | | |
| Conditions | Thickness of sheet, mm | | | 0.7 | 0.7 | 0.2 | 1.3 |
| for press | Length of surplus portion | | | 60 | 2 | 20 | 20 |
| molding | of sheet, mm | | | | | | |
| | Heating Temperature, ° C. | | | 200 | 200 | 200 | 200 |
| | Rentention time, min | | | 1 | 1 | 1 | 1 |
| | Cooling temperature, ° C. | | | 80 | 80 | 80 | 80 |
| | Pressure, MPa | | | 1 | 1 | 1 | 1 |
| Evaluation | Cracks of side portion | | | Poor | Poor | Poor | Particularly |
| | | | | | | | good |
| | Formativeness | | | Particularly | Particularly | Particularly | Poor |
| | | | | Good | Good | Good | |
| | Rigidity | | | Particularly | Particularly | Poor (1.4) | Particularly |
| | (maximum deflection, mm) | | | Good | Good | | Good |
| | | | | (4.0) | (4.0) | | (1.3) |

| | | | | Comparative | Comparative | Comparative | Comparative |
|---|---|---|---|---|---|---|---|
| | Items | Denotation | | Example 5 | Example 6 | Example 7 | Example 8 |
| Composition | (A) Thermosplastic Resin | A-1 | Bisphenol A-type aromatic | 90 | 35 | 60 | |
| of Sheet | | | polycarbonate | | | | |
| | | A-2 | Homo-type polyproplene | | | | 60 |
| | | A-3 | Polybutylene terephthalate | | | | |
| | (B) Inorganic Filler | B-1-1 | Glass chopped strand φ13μ | 10 | 65 | | |
| | | B-1-2 | Glass chopped strand φ7μ | | | | |
| | | B-1-3 | Glass chopped strand φ17μ | | | | 40 |
| | | B-1-4 | Glass chopped strand with | | | | |
| | | | flat-shaped cross-section | | | | |
| | | B-1-5 | Carbon fiber (chopped strand) | | | | |
| | | B-2-1 | Glass flake (FY-M01) | | | | |
| | | B-3-1 | Glass beads (EGB731B) | | | 40 | |
| | Fiber length | | | 320 | 210 | 18 | 2500 |
| | (average length, μm) | | | | | | |
| Conditions | Thickness of sheet, mm | | | 0.7 | 0.7 | 0.7 | 0.7 |
| for press | Length of surplus portion | | | 20 | 20 | 20 | 20 |
| molding | of sheet, mm | | | | | | |
| | Heating Temperature, ° C. | | | 200 | 200 | 200 | 220 |
| | Rentention time, min | | | 1 | 1 | 1 | 1 |
| | Cooling temperature, ° C. | | | 80 | 80 | 80 | 80 |
| | Pressure, MPa | | | 1 | 1 | 1 | 0.2 |
| Evaluation | Cracks of side portion | | | Particularly | Poor | Particularly | Particularly |
| | | | | Good | | Good | Good |
| | Formativeness | | | Particularly | Poor | Particularly | Poor |
| | | | | Good | | Good | |
| | Rigidity | | | Poor (11) | Particularly | Poor (14) | Particularly |
| | (maximum deflection, mm) | | | | Good | | Good |
| | | | | | (2.8) | | (0.9) |

According to the results of the working examples and comparative examples shown in Tables 1-3, the below-described matters were clarified.

In Examples 1-12, because the lengths of the surplus portion of the resin sheet, each of which is represented by 1a or 1b in FIG. 6, were 5 mm to 50 mm, the side portion of the press-molded article did not have any resin-unfilled portion or hole/crack, and the molded article had good outer appearance. Further, since the molded article had high rigidity because of the inorganic filler, when the static load of 4.5 N was applied to the central portion of the molded article, the maximum value of deflection was small. Note that it is also possible to use molds having shapes different from those shown in FIG. 6, for example, molds having shapes shown in FIGS. 1-4.

Meanwhile, in Comparative Example 1 in which the length of the surplus portion was 60 mm, the resin sheet was broken at the time of mold clamping due to adhesion between the end portions of the sheet and the peripheral portion of the mold, the resin sheet did not enter into the internal portion of the cavity, and holes/cracks were generated at the side portion of the molded article.

In Comparative Example 2 in which the length of the surplus portion was 2 mm, the amount of the resin was insufficient, and the side portion of the molded article was not filled.

In Comparative Example 3 in which the thickness of the resin sheet was 0.2 mm, because the sheet was too thin, it was broken at the time of mold clamping, holes/cracks were generated at the side portion of the molded article, and the rigidity of the molded article was insufficient.

In Comparative Example 4 in which the thickness of the resin sheet was 1.3 mm, breakage was not caused at the side portion of the molded article, but the formativeness of the R portion (radiused or curved portion) was insufficient.

In Comparative Example 5 in which the content of the inorganic filler was 10 wt %, when the static load of 4.5 N was applied to the molded article, the maximum deflection exceeded 10 mm, and the rigidity was insufficient.

In Comparative Example 6 in which the content of the inorganic filler was 65 wt %, since the content of the inorganic filler was high and the resin sheet was easily broken, a resin-unfilled portion and holes/cracks were generated at the side portion of the press-molded article. In addition, due to the inorganic filler, the surface smoothness of the design surface was significantly reduced.

In Comparative Example 7 in which glass beads were used as the inorganic filler, because the inorganic filler of the molded article was short, the maximum deflection exceeded 10 mm, and the rigidity was insufficient.

In Comparative Example 8 in which the production was carried out according to the sheet forming method using a glass fiber having a fiber length of 10 to 50 mm, the fiber projected from the surface of the molded article, and the surface smoothness of the design surface was insufficient.

### REFERENCE SIGNS LIST

1: surplus portion of resin sheet
2: resin sheet
3: upper mold
4: lower mold
4a: concave portion of lower mold
4d: depth of concave portion of lower mold (central portion)
4e: side depth of concave portion of lower mold

1. A method for producing a molded body, the method comprising a step of press molding a resin sheet or resin film that comprises a thermoplastic resin (A) and a fibrous inorganic filler (B) between an upper mold and a lower mold, wherein:
the resin sheet comprises 40 to 80 parts by mass of the thermoplastic resin (A) and 20 to 60 parts by mass of the fibrous inorganic filler (B) in 100 parts by mass of the resin sheet; the thickness of the resin sheet is 0.3 to 1.2 mm; the average fiber length of the fibrous inorganic filler (B) in the molded body is 50 to 500 μm; and
the length of a surplus portion of the resin sheet arranged on the concave portion of the lower mold used in press molding is 5 to 50 mm.

2. The method for producing a molded body comprising press molding according to claim 1, wherein the depth of the concave portion of the lower mold used in press molding is 1 to 30 mm.

3. The method for producing a molded body comprising press molding according to claim 1, wherein the ratio of the length of the surplus portion to the depth of the concave portion of the lower mold which is defined as the value of (the length of the surplus portion (mm)/(the depth of the concave portion of the lower mold (mm)) is 1.0 to 10.0.

4. The method for producing a molded body comprising press molding according to claim 1, wherein the resin sheet further comprises a plate-shaped filler in an amount of 0.1 to 10 parts by mass.

5. The method for producing a molded body comprising press molding according to claim 1, wherein the thermoplastic resin (A) includes an aromatic polycarbonate.

6. The method for producing a molded body comprising press molding according to claim 1, wherein the length of the surplus portion is 7 mm to 20 mm.

7. A molded body obtained by the production method according to claim 1.
